(19) United States
(12) Patent Application Publication
(10) Pub. No.: US 2018/0137501 A1
(43) Pub. Date: May 17, 2018

(54) SYSTEM FOR MANIPULATION AND DISTRIBUTION OF ELECTRONIC RESOURCES

(71) Applicant: BANK OF AMERICA CORPORATION, Charlotte, NC (US)

(72) Inventors: Kevin Patrick Condon, Wilmette, IL (US); Robert Scott Seidman, Matthews, NC (US); Robert S. Kerr, Charlotte, NC (US); Brian J. Kehner, Wilmington, DE (US); Lori D. Carpenter, Hockessin, DE (US); Victoria L. Dravneek, Charlotte, NC (US); Jason M. Martin, Charlotte, NC (US); Megan Leslie Steele, Charlotte, NC (US); Deepak Joseph, Charlotte, NC (US)

(21) Appl. No.: 15/377,140

(22) Filed: Dec. 13, 2016

Related U.S. Application Data
(60) Provisional application No. 62/421,727, filed on Nov. 14, 2016.

(51) Int. Cl. G06Q 20/36; H04L 29/08; G06Q 20/32

(52) U.S. Cl. CPC G06Q 20/367; G06Q 20/325; G06Q 20/322; H04L 67/12

(57) ABSTRACT

Embodiments of the invention are directed to a system, method, or computer program product for manipulating and distributing electronic resources. The system accepts a request from a user for a transfer of an electronic resource to a second user and in response, generates a transfer vehicle containing details of the transfer. The transfer of electronic resources is directed and completed through the transmission of the generated transfer vehicle to a device associated with the second user. As only the transfer vehicle is transmitted without the need for additional personal identifying information, a transfer of electronic resources may be completed securely and relatively anonymously in a time frame comparable to that of an exchange of a traditionally used physical resource.

### CROSS-REFERENCE TO RELATED APPLICATIONS

This application claims the benefit of U.S. Provisional Application Ser. No. 62/421,727, entitled “SYSTEM FOR MANIPULATION AND DISTRIBUTION OF ELECTRONIC RESOURCES”, filed Nov. 14, 2016, which is incorporated herein by reference in its entirety.

### BACKGROUND

Computer technology continues to advance and become further integrated into everyday tasks. While exclusively employing electronic resources has become a viable option available to users, there still exists a need to allow those users to quickly complete impromptu interactions solely using electronic resources while retaining the convenience and anonymity provided by physical alternatives.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address these and/or other needs by providing an innovative system, method, and computer program product for manipulating and distributing electronic resources, the system comprising: at least one memory device with computer-readable program code stored thereon; at least one communication device connected to a network; at least one processing device operatively coupled to the at least one memory device and the at least one communication device, wherein the processing device is configured to execute the computer-readable program code to: receive a request from a user via a user application stored on a user device associated with the user for a transfer of an electronic resource, wherein the request contains routing information associated with the transfer of the electronic resource; in response to receiving the request for the transfer of the electronic resource, generate a transfer vehicle, wherein the transfer vehicle is engineered to contain the routing information associated with the transfer of the electronic resource; insert and store the transfer vehicle on the user device; detect an interaction event, wherein the interaction event is a request to transmit the transfer vehicle to a second user device associated with a second user; in response to detecting the interaction event, transmit the transfer vehicle from the user device to the second user device; extract, from the transfer vehicle on the second user device, the routing information associated with the transfer of the electronic resource; and based on the routing information associated with the transfer of the electronic resource, transfer the electronic resource to a designated location associated with the second user.

In some embodiments of the invention, transferring the electronic resource to a designated location associated with the second user further comprises: depositing the electronic resource in an account associated with the second user; and destroying the transfer vehicle.

In some embodiments of the invention, the transfer of the electronic resource comprises a transfer of funds from a financial account associated with the user to a second financial account associated with the second user.

In some embodiments of the invention, the transfer vehicle may be stored on the second user device and applied to a future transaction associated with the second user as currency.

In some embodiments of the invention, the electronic resource is stored in a digital purse associated with the user, wherein the digital purse is a virtual account associated with the user that is maintained separately from other accounts associated with the user.

In some embodiments of the invention, the digital purse has a unique alias that may be provided from the user to the second user in order to direct the transfer of the electronic resource while maintaining anonymity of the user.

In some embodiments of the invention, the digital purse has a limit on the amount of funds that are able to be stored within the digital purse.

In some embodiments of the invention, transmitting the transfer vehicle from the user device to the second user device further comprises: transmitting a control signal to the user device to display the transfer vehicle; and receiving an image of the transfer vehicle via the second user device, wherein the image of the transfer vehicle is captured using the second user device.

In some embodiments of the invention, extracting, from the transfer vehicle on the second user device, the routing information associated with the transfer of the electronic resource further comprising matching a record of the routing information associated with the transfer vehicle transmitted from the user device with the routing information extracted from the transfer vehicle received on the second user device.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides an electronic resource manipulation and distribution system environment, in accordance with one embodiment of the present invention;

FIG. 2 provides a high level process flow for manipulating and distributing electronic resources, in accordance with one embodiments of the present invention; and

FIG. 3 provides a high level process flow illustrating electronic resource transfer vehicles used for transferring an electronic resource between user devices, in accordance with one embodiment of the invention.

### DETAILED DESCRIPTION OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

A “user” as used herein may refer to any entity or individual associated with the electronic resource manipulation and distribution system. In some embodiments, a user may be a mobile device application user and/or a financial institution customer (e.g., an account holder or a person who has an account (e.g., banking account, credit account, or the like)). In some embodiments, identities of an individual may include online handles, usernames, aliases, family names, maiden names, nicknames, or the like. Furthermore, as used herein the term “user device” may refer to any device that employs a processor and memory and can perform computing functions, such as a personal computer or a mobile device, wherein a mobile device is any mobile communication device, such as a cellular telecommunications device (i.e., a cell phone or mobile phone), personal digital assistant (PDA), a mobile Internet accessing device, or other mobile device. Other types of mobile devices may include portable digital assistants (PDAs), pagers, wearable devices, mobile televisions, gaming devices, laptop computers, cameras, video recorders, audio/video player, radio, GPS devices, or any combination of the aforementioned.

In accordance with embodiments of the invention, the terms “financial institution,” “financial entity,” and “entity” may be used to include any organization that processes financial transactions including, but not limited to, banks, credit unions, savings and loan associations, investment companies, stock brokerages, asses management firms, insurance companies and the like. In specific embodiments of the invention, use of the term “bank” is limited to a financial entity in which account-bearing customers conduct financial transactions, such as account deposits, withdrawals, transfers and the like. In other embodiments, an entity may be a business, organization, or the like that is not a financial institution.

An “account” is the relationship that a user has with an entity, such as a financial institution or bank. Examples of accounts include a deposit account, such as a transactional account (e.g., a banking account), a savings account, an investment account, a money market account, a time deposit, a demand deposit, a pre-paid account, a credit account, a non-monetary user profile that includes information associated with the user, or the like. The account is associated with and/or maintained by the entity. In some embodiments, the account is maintained by a third-party entity or financial institution. “Assets,” “funds,” or “resources” include accounts of the user and/or other property owned by the user. The assets may be associated with accounts or may be property that is not associated with a specific account. Examples of assets associated with accounts may be accounts that have cash or cash equivalents, or accounts that are funded with or contain property, such as safety despots box account that jewelry, a trust account that is funded with property, or the like. Examples of assets that may not be associated with accounts may be antiques in a user's home, jewelry in a user's home, or the like. In some embodiments, “electronic resources” may refer to financial assets, funds, and/or resources that are maintained and stored in an electronic form on computer systems or devices. In further embodiments, “electronic resources” may additionally include nonfinancial data such as files, documents, images, video, audio, and the like.

“Authentication information” is any information that can be used to identify of a user. For example, a system may prompt a user to enter authentication information such as a username, a password, a personal identification number (PIN), a passcode, biometric information (e.g., voice authentication, a fingerprint, and/or a retina scan), an answer to a security question, a unique intrinsic user activity, such as making a predefined motion with a user device. This authentication information may be used to authenticate the identity of the user (e.g., determine that the authentication information is associated with the account) and determine that the user has authority to access an account or system.

To “monitor” is to watch, observe, or check something for a special purpose over a period of time. The “monitoring” may occur periodically over the period of time, or the monitoring may occur continuously over the period of time. In some embodiments, a system may actively monitor a database, wherein the system reaches out to the database and watches, observes, or checks the database for changes, updates, and the like. In other embodiments, a system may passively monitor a database, wherein the database provides information to the system and the system then watches, observes, or checks the provided information. A “transaction” or “interaction” refers to any communication between one or more users, one or more financial institutions, and/or other entities monitoring the user's activities. For example, a transaction may refer to a purchase of goods or services, a return of goods or services, a payment transaction, a credit transaction, or other interaction involving a user's account.

Embodiments of the invention are directed to a system, method, or computer program product for manipulating and distributing electronic resources. The system accepts a request from a user for a transfer of an electronic resource to a second user and in response, generates a transfer vehicle containing details of the transfer. The transfer of electronic resources is directed and completed through the transmission of the generated transfer vehicle to a device associated with the second user. As only the transfer vehicle is transmitted without the need for additional personal identifying information, a transfer of electronic resources may be completed securely and relatively anonymously in a time frame comparable to that of an exchange of a traditionally used physical resource.

While the use of electronic resources, especially with regards to electronic payment and banking, is becoming more prevalent, physical currency, such as cash, is still employed by many to complete impromptu, informal transactions (e.g. tipping, on-the-spot donations, bill or fare splitting, or the like) for relatively small amounts due to the convenience, speed, and/or anonymity of the physical transaction. For example, if a user wished to tip a doorman, neither party would tend to prefer to take the time to exchange, with a relative stranger, the account numbers or other personal identifying information traditionally required to direct and complete an electronic payment. The present invention solves this technical problem which arises from attempting to use electronic payment methods to complete on-the-spot payments by allowing for rapid and anonymous transfers of electronic resources between parties and thereby providing a viable option for a user wishing to abandon physical payment methods, and instead, exclusively use electronic payment methods.

Embodiments of the present invention address the above needs and/or achieve other advantages by providing apparatuses (e.g., a system, computer program product and/or other devices) and methods for manipulating and distributing electronic resources.

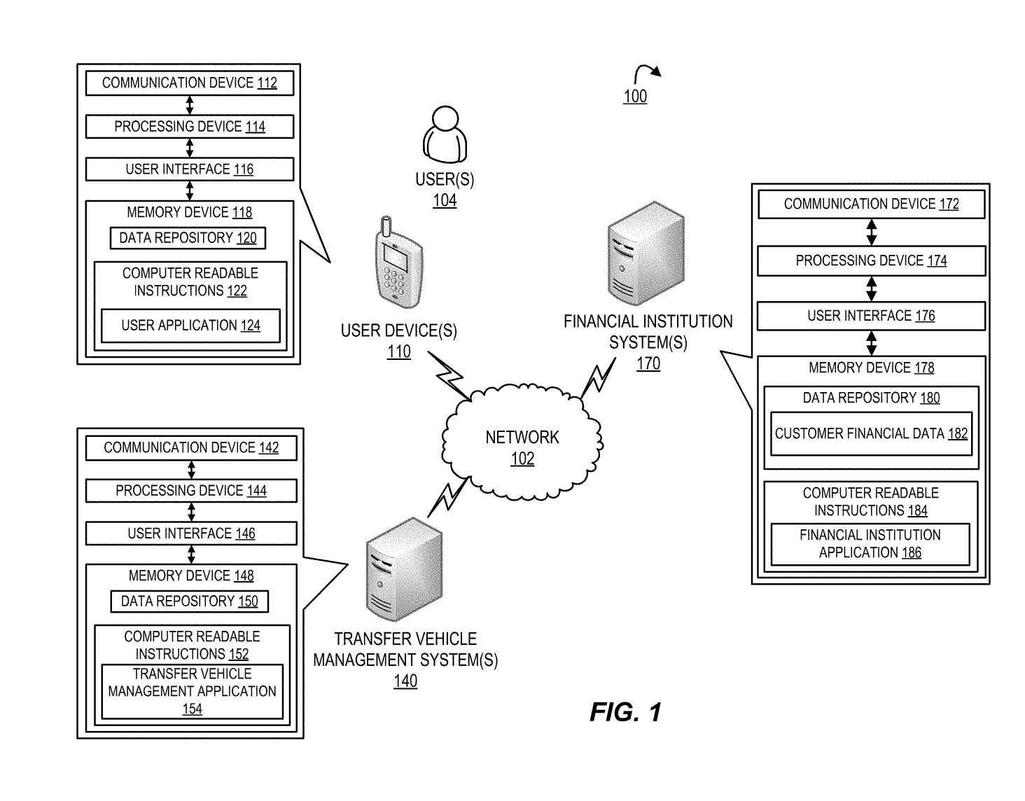

Referring to FIG. 1, the figure illustrates an electronic resource manipulation and distribution system environment 100, in accordance with some embodiments of the invention. The environment 100 includes a user device 110 associated or used with authorization of a user 104 (e.g., a mobile application user, and the like), a transfer vehicle management system 140, and a financial institution system 170.

As used herein, a “processing device,” such as the processing devices 114, 144, and 174 generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may further include functionality to operate one or more software programs based on computer-executable program code thereof, which may be stored in a memory. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “user interface” such as the user interfaces 116, 146, and 176 generally includes a plurality of interface devices and/or software that allow a customer to input commands and data to direct the processing device to execute instructions. For example, the user interfaces presented in FIG. 1 may include a graphical user interface (GUI) or an interface to input computer-executable instructions that direct the processing device to carry out specific functions. The user interface employs certain input and output devices to input data received from a user or output data to a user. These input and output devices may include a display, mouse, keyboard, button, touchpad, touch screen, microphone, speaker, LED, light, joystick, switch, buzzer, bell, and/or other customer input/output device for communicating with one or more customers.

As used herein, a “memory device” such as memory devices 118, 148, and 178 generally refers to a device or combination of devices that store one or more forms of computer-readable media for storing data and/or computer-executable program code/instructions. Computer-readable media is defined in greater detail below. For example, in one embodiment, the memory device includes any computer memory that provides an actual or virtual space to temporarily or permanently store data and/or commands provided to the processing device when it carries out its functions described herein.

As used herein, a “communication interface” generally includes a modem, server, transceiver, and/or other device for communicating with other devices on a network, and/or a user interface for communicating with one or more customers. Referring again to FIG. 1, the communication devices 112, 142, and 172 are communication interfaces having one or more devices configured to communicate with one or more other devices on a network, such as a mobile device, a personal computing device, a mobile banking system, other financial institution banking systems, third party systems, and/or the like. The processing device is configured to use the network communication device to transmit and/or receive data and/or commands to and/or from the other devices connected to the network.

The systems and devices communicate with one another over the network 102 and perform one or more of the various steps and/or methods according to embodiments of the disclosure discussed herein. The network 102 may include a local area network (LAN), a wide area network (WAN), and/or a global area network (GAN). The network 102 may provide for wireline, wireless, or a combination of wireline and wireless communication between devices in the network. In one embodiment, the network 102 includes the Internet.

The user device 110 includes a communication device 112 communicably coupled with a processing device 114, which is also communicably coupled with a memory device 118. In some embodiments, the communication device 112 may also comprise a GPS transceiver capable of determining a geographic location associated with the user device 110. The processing device 114 is configured to control the communication device 112 such that the user device 110 communicates across the network 102 with one or more other systems. The processing device 114 is also configured to access the memory device 118 in order to read the computer readable instructions 122, which in some embodiments includes a user application 124. The user application 124 allows for communication of the user device 110 with the other systems and devices within the environment 100 such as the transfer vehicle management system 140, and financial institution system 170. The user application 124 allows the user 104 to receive information transmitted as well as input information requested by the other systems and communicate with a financial institution, one or more third parties, and/or other entities. The memory device 118 also includes a data repository 120 or database for storing pieces of data that can be accessed by the processing device 114.

The transfer vehicle management system 140 includes a communication device 142 communicably coupled with a processing device 144, which is also communicably coupled with a memory device 148. The processing device 144 is configured to control the communication device 142 such that the transfer vehicle management system 140 communicates across the network 102 with one or more other systems. The processing device 144 is also configured to access the memory device 148 in order to read the computer readable instructions 152, which in some embodiments includes a transfer vehicle management application 154. The transfer vehicle management application 154 allows for communication with the other systems and devices within the environment 100 such as the user device 110 and the financial institution system 170. The memory device 148 also includes a data repository 150 or database for storing pieces of data that can be accessed by the processing device 144. In some embodiments, the transfer vehicle management system 140 may be part of the financial institution systems 170 or the user device 110.

The financial institution system 170 may be a single system or multiple systems networked with one another to perform one or more process steps discussed herein. As illustrated in FIG. 1, in one embodiment of the invention, the financial institution system 170 includes a processing device 174 operatively coupled to a network communication device 172 and a memory device 178. In certain embodiments, the financial institution system 170 is operated by a first entity, such as a financial institution, while in other embodiments, the financial institution system 170 is operated by an entity other than a financial institution.

The financial institution system 170 includes a communication device 172 communicably coupled with a processing device 174, which is also communicably coupled with a memory device 178. The processing device 174 is configured to control the communication device 172 such that the financial institution system 170 communicates across the network 102 with one or more other systems. The processing device 174 is also configured to access the memory device 178 in order to read the computer readable instructions 184, which in some embodiments includes a financial institution application 186. The financial institution application 186 allows for communication with the other systems and devices within the environment 100 such as the user device 110 and the transfer vehicle management system 140. The memory device 178 also includes a data repository 180 or database for storing pieces of data that can be accessed by the processing device 174.

The user application 124, the transfer vehicle management application 140, and the financial institution system 170 are for instructing the processing devices on their respective systems to perform various steps of the methods discussed herein, and/or other steps and/or similar steps. In various embodiments, one or more of the various applications discussed are included in the computer readable instructions stored in a memory device of one or more systems or devices other than their respective systems and/or devices. For example, in some embodiments, the transfer vehicle management application 154 is stored and configured for being accessed by a processing device of the financial institution system 170 connected to the network 102. In various embodiments, the user application 124, the transfer vehicle management application 154, and the financial institution application 186 are stored and executed by different systems/devices. In some embodiments, the discussed applications may be similar and may be configured to communicate with one another. In some embodiments, the various applications may be considered to be working together as a singular application despite being stored and executed on different systems.

In various embodiments, one of the systems discussed above, such as the financial institution system 170, is more than one system and the various components of the system are not collocated, and in various embodiments, there are multiple components performing the functions indicated herein as a single device. For example, in one embodiment, multiple processing devices perform the functions of the processing device 174 of the financial institution system 170 described herein.

In various embodiments, the user device 110, the transfer vehicle management system 140, the financial institution system 170, and/or other systems may perform all or part of a one or more method or process steps discussed above and/or other method steps in association with the method steps discussed above. Furthermore, some or all the systems/devices discussed here, in association with other systems or without association with other systems, in association with steps being performed manually or without steps being performed manually, may perform one or more of the steps of one or more of the method discussed herein, or other methods, processes or steps discussed herein or not discussed herein.

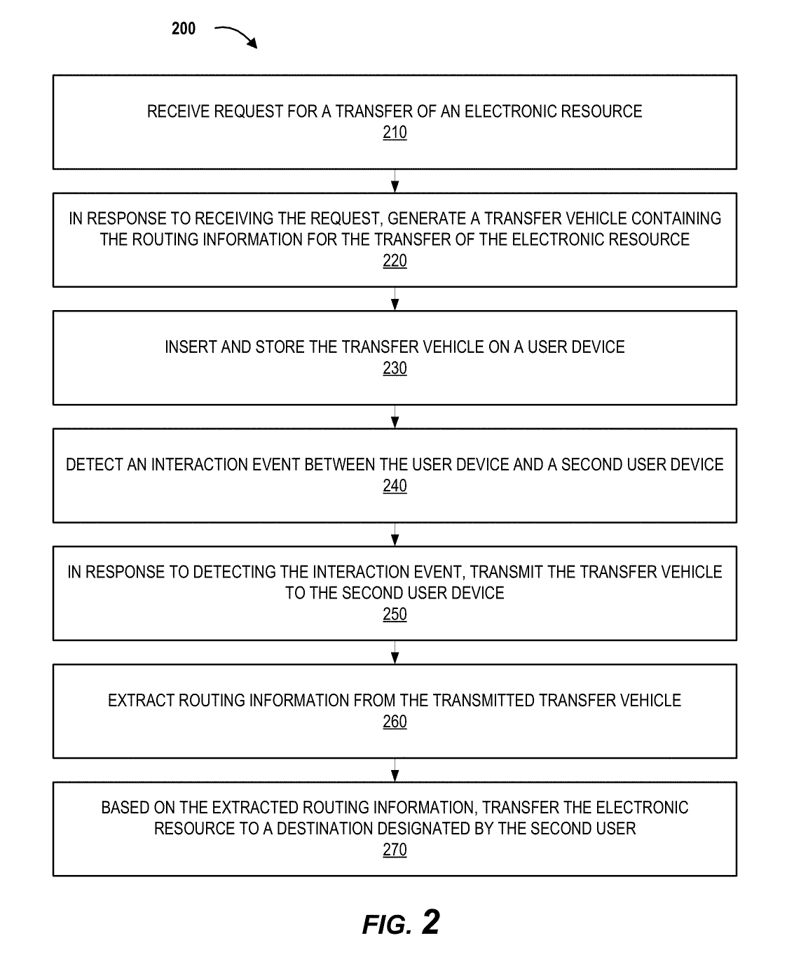

FIG. 2 illustrates a high level process flow for manipulating and distributing electronic resources 200, in accordance with one embodiment of the invention. As illustrated in block 202, the process 200 is initiated by first receiving a request for a transfer of an electronic resource. The request for the transfer of the electronic resource is received from a user via a user device. In some embodiments, the user interacts with a user interface of the user device to interact with a user application stored in the memory of the user device in order to input commands and request the transfer of electronic resources. In some embodiments of the invention, the user may be prompted to select, via the user application on the user device, one or more accounts or other storage locations associated with the user as the source of the electronic resource transfer. For example, the user may choose to select his/her checking account as a source of the electronic funds to be transferred to a recipient after being prompted by the system to make such a decision. In other embodiments, the user may have been previously prompted by the system to select a default account or storage location to act as a source for any future electronic resource transfers, wherein the system automatically designates the default account or storage location as the source of the transfer upon request for the transfer without requiring the user to designate the source at the time of the request.

In some embodiments, the request for the transfer of electronic resources further comprises routing information associated with the transfer of electronic resources. Routing information may include information related to the account or other storage location associated with the user that is designated as the source of the electronic resource transfer. In some embodiments, the user may be prompted to select an amount of the electronic resource that the user wishes to transfer. In one example, the user may be prompted to select an amount of money that the user wishes to transfer out of his/her online checking account.

Electronic resources may refer to financial assets, funds, and/or resources that are maintained and stored in an electronic form on a computer system or device. For example, electronic resources may include funds stored in an online banking account maintained by a financial institution. In some embodiments, electronic funds may also refer to other digital currencies and cryptocurrencies which may be stored on a user device or maintained in an account by a third party. In further embodiments, “electronic resources” may additionally include nonfinancial data such as files, documents, images, video, audio, and the like. For example, a user may wish to transfer a picture stored on the user's device to a second device associated with a second user.

In some embodiments, the electronic resource is held within a digital purse, wherein the digital purse is an account or storage location associated with the user that is maintained separately from other financial accounts associated with the user. In some embodiments, the digital purse acts as a virtual account separate from the user's other financial accounts (e.g. checking, savings, etc.), wherein the digital purse has a separate account number, alias, or other identifier that is able to be exchanged between the user and payee in order to complete a transaction without requiring the release of personal identifying information. In this way, while still allowing a transfer of funds to be accurately directed, a level of anonymity may be maintained and the payor (user) and payee (recipient) are able to successfully complete a transaction without the need to disclose credit card numbers, financial account numbers, phone numbers, full names, or other personal information that the payor or payee might prefer to remain anonymous.

In some embodiments, the digital purse may allow for a user or another party to load funds from another account onto the digital purse account for spending. In some embodiments, the digital purse may have an associated fund capacity in order to help a user budget his/her funds, set limits on spending, and limit risk of misappropriation if the digital purse were to be illegally accessed. In some embodiments, the digital purse may be at least partially stored locally on a user device and/or remotely on a financial institution system and/or a third party system, wherein the financial institution and/or third party maintain the digital purse account. In some embodiments, the digital purse may have a separate account number, code, alias, token, image, or some other unique identifier or method of device communication that is able to be quickly exchanged between the payor and payee to complete a transfer or transaction. In this way, a transfer of electronic funds may be completed within a time frame similar to that of using cash while maintaining anonymity of the payor and payee.

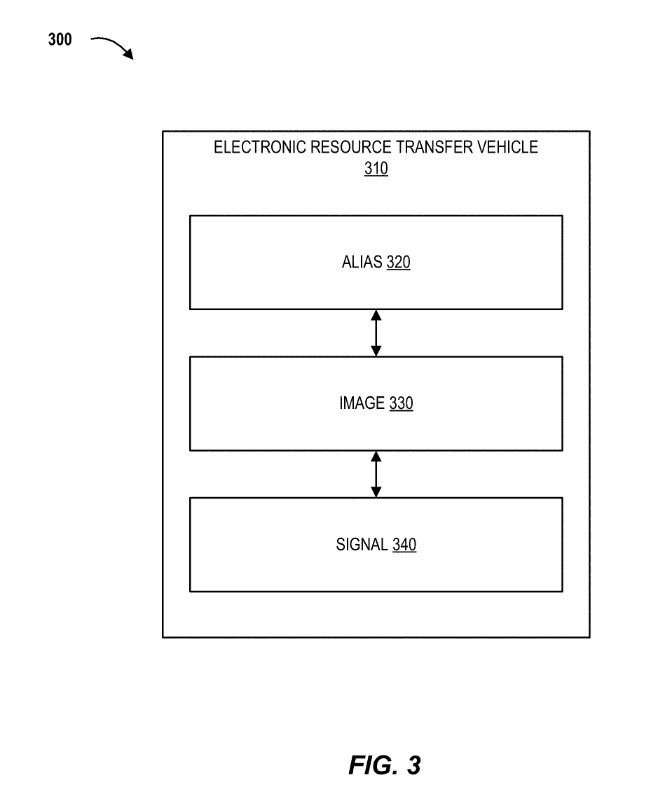

As illustrated in block 220 of FIG. 2, the system generates a transfer vehicle in response to receiving the request from the user for the transfer of an electronic resource. Referring now to FIG. 3, which provides a high level process flow illustrating various electronic resource transfer vehicles used to transfer an electronic resource 300, as illustrated in block 310, an electronic resource transfer vehicle may be a generated item exchanged between users to complete a transfer of an electronic resource or funds, wherein the vehicle transmit the electronic resource information between user devices. In some embodiments, the vehicle may contain details associated with the transfer of the electronic resource. For example, a token used for a transfer of funds may be engineered to contain routing information associated with a sender and/or recipient and an amount of funds to be transferred. In some embodiments, the vehicle is generated by a transfer vehicle management system.

As illustrated in block 320 of FIG. 3, the transfer vehicle may be an alias, wherein the alias is a unique identifier such as a code, username, password, account number, or the like. In some embodiments the alias may be generated using unique hardware information associated with the user's device such as a serial number or the like. In some embodiments, the vehicle is a temporary and is generated to only be used in a limited number of electronic resource transfers. For example, the system may provide the user with a temporary code that may be provided to a recipient, wherein the code may be redeemed once by the recipient for an electronic resource. In some embodiments, an alias or the like may only be used as a unique identifier used to direct a transfer of an electronic resource, wherein the use of an alias or the like may be combined with other methods of transferring an electronic resource contained herein to aid in completing a transfer. In some embodiments, a token may be transmitted with an electronic resource transfer vehicle to act as an identifier in order to authenticate a user and/or direct an electronic resource transfer. In some embodiments, a token may be an electronic resource transfer vehicle.

As illustrated in block 330 of FIG. 3, in some embodiments of the invention, the vehicle generated by the system may be an image. In some embodiments, the image may have been captured using a camera associated with the user device. In other embodiments, the image may be an image generated by the system. In yet other embodiments, the image may be a preexisting image selected by the user or the system. In some embodiments, the vehicle may be an image of a completed check captured by a camera on the user device. In other embodiments, the vehicle may be an image of a digital check generated from a digital checkbook stored by the user device, wherein the fields of the digital check are completed by the user via the user device.

In some embodiments of the invention, the electronic resource transfer vehicle generated by the system may be an image of a credit card, debit card, or other payment vehicle. In some embodiments, the image of the payment vehicle, such as a credit card, debit card, or the like, may be captured using a camera on a user device. In some embodiments, the payment vehicle may be a digital card that is stored on a user device in a digital purse or wallet, wherein an image of the digital card may be captured scanned using a camera or the like on a user device. In some embodiments, the vehicle may be an image of a quick response (QR) code or barcode generated by the system, wherein the QR code or barcode may be captured or scanned using a camera, barcode reader, or the like by another device.

As illustrated in block 340 of FIG. 3, in some embodiments, the transfer vehicle generated by the system may be a signal generated by one or more user devices such as near-field communication (NFC), a beacon, or other similar wireless, device-identifying technology, wherein the signal uniquely identifies the user device used to generate the identifying signal. In some embodiments, in response to a user initiating a transfer of an electronic resource, the system may present the user with a list of other nearby user devices transmitting communication signals which are available for an interaction, wherein the other devices are identified with a unique identifier such as a username, an alias, unique device ID, or the like associated with the other devices which allow an electronic resource transfer to be accurately directed while retaining anonymity. In this way, only the unique identifier may be presented to another user while other personal information such as credit card numbers, financial account numbers, phone numbers, full names, or the like may be kept private.

In some embodiments, the vehicle may be generated from the physical contact of at least two user devices, wherein the physical contact is detected by accelerometers contained within the user devices, and wherein, upon detection, signals and data output from the accelerometers may be compared and matched in order to verify and direct a transfer or transaction. For example, the system may compare the force of impact detected and measured by the accelerometers in each of two user devices involved in the physical contact combined with global positioning system (GPS) information from the user devices in order to verify the identities and locations of the user devices and users involved in a requested transaction and direct and authorize a transfer of electronic resources.

In some embodiments, the routing information associated with the transfer of the electronic resource is contained within the generated vehicle. In some embodiments, the generated vehicle is engineered, wherein the routing information is embedded or contained within the vehicle. In some embodiments the routing information is encrypted within the vehicle so as to only allow the system to be able to de-encrypt the information upon receiving and processing the vehicle on a second user device. In some embodiments the routing information is used to confirm the successful transfer of a vehicle, wherein a record of the routing information included with the generated vehicle that was transmitted from a first user device is matched to the routing information of the vehicle received by a second user device. In this way, the system may match the transmitted routing information with the received routing information in order to verify the successful transmission of the vehicle and ensure that the correct recipient received the vehicle with the correct contents.

Referring now back to FIG. 2, as illustrated in block 230, the system inserts and stores the generated vehicle onto the user device. In some embodiments, the system temporarily stores the vehicle on user device, wherein the system removes the vehicle from the user device upon transmitting the vehicle to a second user device

As illustrated in block 240 of FIG. 2, the system detects the occurrence of an interaction event between two or more user devices. An interaction event may be a request from at least one user to transmit the generated vehicle to at least one other user device. In some embodiments, an interactions event comprises one or more users associated with a transfer of an electronic resource requesting to transmit and/or receive an electronic resource via a user application. In other embodiments, an interaction event may comprise a user device capturing an image of a transfer vehicle. In some embodiments, an interaction event may comprise the system inserting and storing a transfer vehicle on the user device. In other embodiments, an interaction event may comprise at least two user devices being within a predetermined range from one another, wherein the user devices may communicate with one another via wireless communication. In other embodiments, an interaction event may comprise the detection of a signal generated from two or more user devices interacting with one another. For example, an interaction event may be a signal generated from an accelerometer and/or GPS associated with a user device upon the user device coming into contact with at least one other user device.

As illustrated in block 250 of FIG. 2, the system transmits the vehicle to a second user device in response to detecting the interaction event. In some embodiments, in response to inserting the vehicle onto the user device and detecting an interaction event, the system may transmit a control signal to the user device to present the vehicle to be transmitted. For example, the system may command the user device to display the vehicle on a display associated with the user device, wherein a second user device may capture an image or scan the displayed vehicle. In another example, the system may command the user device to transmit the vehicle via NFC or some other form of communication.

In some embodiments, transmitting the transfer vehicle to a second user device may comprise the second user device capturing an image of a payment method such as a check, credit card, QR code, barcode, or other generated image engineered to act as a transfer vehicle, wherein the image captured by the second user device may act as the transmitted vehicle.

In some embodiments, the system may transmit the vehicle to more than one other user devices. In some embodiments, the system may transmit the vehicle to multiple other user devices simultaneously. In other embodiments, the system may transmit the vehicle to multiple other user devices sequentially or in a predetermined order.

As illustrated in block 260 of FIG. 2, the system extracts the routing information from the transfer vehicle received by the second user device. In some embodiments, upon the routing information being successfully extracted from the vehicle, the system may destroy the vehicle to maintain security and integrity of the transaction to ensure that the transaction is only completed once using the vehicle and account information may not be saved by other users. In other embodiments, the vehicle may be engineered to be redeemed by one or more recipients a predetermined number of times before the vehicle is discarded, made inactive, or destroyed.

In some embodiments, the information extracted from the vehicle is directly transmitted to a financial institution or a financial institution application associated with the recipient. In this way, the user's financial information is never stored on the second user device thereby maintaining anonymity of the user's financial and personal information.

As illustrated in block 270 of FIG. 2, the system transfers the electronic resource to a destination or storage location designated by recipient or second user. In some embodiments, the destination may be an account maintained by a financial institution, wherein the electronic resource may be deposited in an account associated with the recipient. In other embodiments, the destination may be a data repository associated with the second user device or other device, wherein the electronic resource may be stored for later user. For example, an electronic resource may be stored for deposit at a later time or applied to a future transfer or transaction. In this way, a transfer vehicle representing an electronic resource, such as a QR code or the like, may not be immediately deposited but instead stored and later transferred or exchanged with another user, similar to currency, to complete a future transaction.

In some embodiments, the user may receive a message or alert via the user application, email, text, or the like on the user device that the transfer of the electronic resource was successful. In some embodiments, the user may be prompted by the system via a message or alert to confirm a transfer of an electronic resource before a transfer vehicle is transmitted to a recipient. In the same way, a recipient may be prompted by the system to confirm that the recipient wishes to receive the transfer of the electronic resource.

In some embodiments, the system may require the authentication of the identities of the user and/or the recipient before the transfer of an electronic resource may be authorized. In some embodiments, the system may require a password or the like. In some embodiments, the system may extract hardware information such as a serial number or the like from a user device associated with the user or recipient in order to authenticate an identity of the user or recipient respectively. In some embodiments, the system may extract biometric information to authenticate the user and/or recipient. For example, the system may employ a fingerprint scanner on a user device to authenticate an identity of a user and/or recipient and authorize a transfer of an electronic resource.

In some embodiments of the invention one or more of the systems described herein may be combined with each other, or otherwise perform the functions of the other systems described herein. In other embodiments of the invention one or more of the applications described herein may be combined with each other, or otherwise perform the functions of the other applications described herein. Furthermore, the applications may be any type of application, such as an application stored on a desktop, server, or other device, a mobile application stored on a mobile device, a cloud application, or other like application. As such, the applications described herein, or portions of the applications described herein may be stored and operated on any of the systems or devices described herein. For example, a portion of one or more applications may be stored on the user device, or may be included as a portion of financial institution applications, such as an online banking application, in order to achieve embodiments of the inventions described herein.

It should be understood, that the systems and devices described in FIG. 1, or other devices not specifically described herein, may be configured to establish a communication link with each other in order to accomplish the steps of the processes described herein. The link may be an internal link within the same entity (e.g., within the same financial institution or device provider) or a link with the other systems of entities (e.g., social networking systems, third-party systems, or the like). In some embodiments, the systems may be configured for monitoring the applications and devices that the system(s) utilize as data sources. The information received from monitoring may be provided via wireless network path portions through the Internet. When the systems or devices are not monitoring a source or are not being monitoring, the information need not be transmitted from the source through the Internet to the destination, although it could be. The sources of information may be made continuously available, however, continuously available does not necessarily mean that the sources actually continuously generates data, but that a source is continuously available to generate and send data real-time (e.g., instantaneously and/or within a few seconds, or the like) of receiving a request for it. In any case, the sources may be continuously available to receive and/or generate information, in some cases in digitized data in Internet Protocol (IP) packet format. In response to continuously monitoring the real-time data feeds from the various systems or devices, the system may be configured to provide target information to the user and/or allow the user to make changes to or control the applications and/or devices.

Moreover, it should be understood that the process flows described herein include transforming the information sent and/or received from the applications of the different systems (e.g., internally or externally) and/or the devices from one or more data formats into a data format associated with an application for display to the user on the user device. There are many ways in which information is converted within the system environment. This may be seamless, as in the case of upgrading to a newer version of a computer program. Alternatively, the conversion may require processing by the use of a special conversion program, or it may involve a complex process of going through intermediary stages, or involving complex “exporting” and “importing” procedures, which may converting to and from a tab-delimited or comma-separated text file. In some cases, a program may recognize several data file formats at the data input stage and then is also capable of storing the output data in a number of different formats. Such a program may be used to convert a file format. If the source format or target format is not recognized, then at times a third program may be available which permits the conversion to an intermediate format, which can then be reformatted.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. patent | | |
|---|---|---|---|
| Docket Number | application Ser. No. | Title | Filed On |
| 5181US2.014033.1711 | 13/536,860 | SYSTEM FOR PRE-PROCESSING | Jun. 28, 2012 |
| | | SALES RETURNS | |
| 5181US1.014033.1648 | 13/536,864 | MOBILE SYSTEM FOR PRE- | Jun. 28, 2012 |
| | | PROCESSING SALES RETURNS | |
| 5270US1.014033.1687 | 13/572,288 | READABLE INDICIA FOR | Aug. 10, 2012 |
| | | ADVERTISEMENTS | |
| 5270US2.014033.1688 | 13/572,311 | ASSESSING ADVERTISEMENT | Aug. 10, 2012 |
| | | IMPACT USING | |
| | | ADVERTISEMENT READABLE | |
| | | INDICIA | |
| 5271US1.014033.1693 | 13/584,325 | GENERATING READABLE | Aug. 13, 2012 |
| | | INDICIA CUSTOMIZED FOR | |
| | | PRODUCT INFORMATION | |
| 5272US1.014033.1694 | 13/554,036 | READABLE INDICIA FOR BILL | Jul. 20, 2012 |
| | | PAYMENT | |
| 5273US1.014033.1690 | 13/589,639 | READABLE INDICIA FOR | Aug. 20, 2012 |
| | | HEALTHCARE PAYMENT CODES | |
| 5273US2.014033.1691 | 13/589,758 | READABLE INDICIA FOR | Aug. 20, 2012 |
| | | MEDICAL OFFICE PAYMENT | |
| 5273US3.014033.1692 | 13/589,904 | READABLE INDICIA FOR | Aug. 20, 2012 |
| | | INSURANCE PAYMENT | |
| 5274US1.014033.1695 | 13/554,108 | READABLE INDICIA FOR A | Jul. 20, 2012 |
| | | PAYMENT CLAIM | |
| 5274US2.014033.1696 | 13/554,047 | READABLE INDICIA FOR A | Jul. 20, 2012 |
| | | REBATE REQUEST | |
| 5275US1.014033.1704 | 13/562,633 | MOBILE DEVICE FOR FUEL | Jul. 31, 2012 |
| | | PURCHASE | |
| 5275US2.014033.1732 | 13/562,614 | READABLE INDICIA FOR FUEL | Jul. 31, 2012 |
| | | PURCHASE | |
| 5275US3.014033.1733 | 13/562,807 | OFFERS ASSOCIATED WITH | Jul. 31, 2012 |
| | | FUEL PURCHASE | |
| 5275US4.014033.1734 | 13/562,623 | READABLE INDICIA FOR FUEL | Jul. 31, 2012 |
| | | PURCHASE | |
| 5276US1.014033.1686 | 13/589,308 | TIME-SENSITIVE READABLE | Aug. 20, 2012 |
| | | INDICIA FOR FUNDRAISING | |
| 5295US1.014033.1689 | 13/586,237 | PRE-SET READABLE INDICIA | Aug. 15, 2012 |
| | | FOR TO FACILITATE PAYMENT | |
| | | DURING A TRANSACTION WITH | |
| | | A MERCHANT WHEN THERE IS | |
| | | LIMITED NETWORK | |
| | | CONNECTIVITY | |
| 5295US2.014033.1731 | 13/586,231 | PRE-SET READABLE INDICIA | Aug. 15, 2012 |
| | | FOR VENDOR USE | |
| 5356US1.014033.1723 | 13/561,577 | OFFER AGGREGATION | Jul. 30, 2012 |
| 5356US2.014033.1724 | 13/561,583 | SEQUENTIAL OFFER | Jul. 30, 2012 |
| | | AGGREGATION | |
| 5357US1.014033.1725 | 13/561,588 | OFFERS BASED ON USER | Jul. 30, 2012 |
| | | ACTIVITY | |
| 5358US1.014033.1726 | 13/561,554 | INCENTIVE FOR OFFER | Jul. 30, 2012 |
| | | DISTRIBUTION | |
| 5362US1.014033.1736 | 13/595,413 | READABLE INDICIA FOR | Aug. 27, 2012 |
| | | PRODUCT REGISTRATION | |
| 5363US1.014033.1737 | 13/619,385 | NOTIFICATION OF | Sep. 14, 2012 |
| | | ALTERNATIVE PAYMENT | |
| | | CHANNEL | |
| 5364US1.014033.1735 | 13/595,421 | READABLE INDICIA FOR | Aug. 27, 2012 |
| | | PROMOTIONS | |
| 5457US1.014033.1809 | 13/732,377 | PROVIDING USER INFORMATION | Jan. 1, 2013 |
| | | BY PRESENTING READABLE | |
| | | INDICIA WITH MOBILE DEVICE | |
| 5457US2.014033.1826 | 13/732,378 | PROVIDING INFORMATION | Jan. 1, 2013 |
| | | FROM USE OF READABLE | |
| | | INDICIA WITH MOBILE DEVICE | |
| 5457US3.014033.1827 | 13/732,380 | IDENTITY PROTECTION AND | Jan. 1, 2013 |
| | | DISTRIBUTION SYSTEM | |
| 5501US1.014033.1808 | 13/667,580 | MOBILE DEVICE FOR MULTIPLE | Nov. 2, 2012 |
| | | PAYMENT MODES | |
| 4812US1.014033.1425 | 13/210,045 | SYSTEM AND METHOD FOR | Aug. 15, 2011 |
| | | CREDENTIAL LENDING | |
| 6081US1.014033.2139 | 14/196,947 | ATM TOKEN CASH | Mar. 4, 2014 |
| | | WITHDRAWAL | |
| 6079US1.014033.2141 | 14/196,257 | FOREIGN EXCHANGE TOKEN | Mar. 4, 2014 |
| 6075US1.014033.2146 | 14/196,292 | FLEXIBLE FUNDING ACCOUNT | Mar. 4, 2014 |
| | | TOKEN ASSOCIATIONS | |
| 6075US2.014033.2147 | 14/196,350 | ACCOUNT TOKEN | Mar. 4, 2014 |
| | | ASSOCIATIONS BASED ON | |
| | | SPENDING THRESHOLDS | |
| 6074US1.014033.2148 | 14/196,030 | CONTROLLING TOKEN | Mar. 4, 2014 |
| | | ISSUANCE BASED ON EXPOSURE | |
| 6072US1.014033.2151 | 14/196,364 | LIMITING TOKEN | Mar. 4, 2014 |
| | | COLLABORATION NETWORK | |
| | | USAGE BY USER | |
| 6072US2.014033.2152 | 14/196,373 | LIMITING TOKEN | Mar. 4, 2014 |
| | | COLLABORATION NETWORK | |
| | | USAGE BY TOKEN | |
| 6071US1.014033.2153 | 14/196,798 | TOKEN COLLABORATION | Mar. 4, 2014 |
| | | NETWORK | |
| 6071US2.014033.2154 | 14/196,802 | FORMATION AND FUNDING OF A | Mar. 4, 2014 |
| | | SHARED TOKEN | |
| 6079US2.014033.2173 | 14/196,274 | FOREIGN CROSS-ISSUED TOKEN | Mar. 4, 2014 |
| 6152US1.014033.2195 | 14/196,405 | TOKEN USAGE SCALING BASED | Mar. 4, 2014 |
| | | ON DETERMINED LEVEL OF | |
| | | EXPOSURE | |
| 6319US1.014033.2294 | 14/457,940 | PERSON-TO-PERSON (P2P) | Aug. 12, 2014 |
| | | PAYMENTS VIA A SHORT- | |
| | | RANGE WIRELESS PAYMENT | |
| | | BEACON | |

What is claimed is:

1. A system for manipulating and distributing electronic resources, the system comprising:
at least one memory device with computer-readable program code stored thereon;
at least one communication device connected to a network;
at least one processing device operatively coupled to the at least one memory device and the at least one communication device, wherein the processing device is configured to execute the computer-readable program code to:
receive a request from a user via a user application stored on a user device associated with the user for a transfer of an electronic resource, wherein the request contains routing information associated with the transfer of the electronic resource;
in response to receiving the request for the transfer of the electronic resource, generate a transfer vehicle, wherein the transfer vehicle is engineered to contain the routing information associated with the transfer of the electronic resource;
insert and store the transfer vehicle on the user device;
detect an interaction event, wherein the interaction event is a request to transmit the transfer vehicle to a second user device associated with a second user;
in response to detecting the interaction event, transmit the transfer vehicle from the user device to the second user device;
extract, from the transfer vehicle on the second user device, the routing information associated with the transfer of the electronic resource; and
based on the routing information associated with the transfer of the electronic resource, transfer the electronic resource to a designated location associated with the second user.

2. The system of claim 1, wherein transferring the electronic resource to a designated location associated with the second user further comprises:
depositing the electronic resource in an account associated with the second user; and
destroying the transfer vehicle.

3. The system of claim 1, wherein the transfer of the electronic resource comprises a transfer of funds from a financial account associated with the user to a second financial account associated with the second user.

4. The system of claim 1, wherein the transfer vehicle may be stored on the second user device and applied as currency to a future transaction associated with the second user.

5. The system of claim 1, wherein the electronic resource is stored in a digital purse associated with the user, wherein the digital purse is a virtual account associated with the user that is maintained separately from other accounts associated with the user.

6. The system of claim 5, wherein the digital purse has a unique alias that may be provided from the user to the second user in order to direct the transfer of the electronic resource while maintaining anonymity of the user.

7. The system of claim 5, wherein the digital purse has a limit on an amount of funds that are able to be stored within the digital purse.

8. The system of claim 1, wherein transmitting the transfer vehicle from the user device to the second user device further comprises:
transmitting a control signal to the user device to display the transfer vehicle; and
receiving an image of the transfer vehicle via the second user device, wherein the image of the transfer vehicle is captured using the second user device.

9. The system of claim 1, wherein extracting, from the transfer vehicle on the second user device, the routing information associated with the transfer of the electronic resource further comprising matching a record of the routing information associated with the transfer vehicle transmitted from the user device with the routing information extracted from the transfer vehicle received on the second user device.

10. A computer program product for manipulating and distributing electronic resources, the computer program product comprising at least one non-transitory computer readable medium having computer-readable program code portions embodied therein, the computer-readable program code portions comprising:
an executable portion configured for receiving a request from a user via a user application stored on a user device associated with the user for a transfer of an electronic resource, wherein the request contains routing information associated with the transfer of the electronic resource;
an executable portion configured for, in response to receiving the request for the transfer of the electronic resource, generating a transfer vehicle, wherein the transfer vehicle is engineered to contain the routing information associated with the transfer of the electronic resource;
an executable portion configured for inserting and storing the transfer vehicle on the user device;
an executable portion configured for detecting an interaction event, wherein the interaction event is a request to transmit the transfer vehicle to a second user device associated with a second user;
an executable portion configured for, in response to detecting the interaction event, transmitting the transfer vehicle from the user device to the second user device;
an executable portion configured for, extracting, from the transfer vehicle on the second user device, the routing information associated with the transfer of the electronic resource; and
an executable portion configured for, based on the routing information associated with the transfer of the electronic resource, transferring the electronic resource to a designated location associated with the second user.

11. The computer program product of claim 10, wherein transferring the electronic resource to a designated location associated with the second user further comprises:
depositing the electronic resource in an account associated with the second user; and
destroying the transfer vehicle.

12. The computer program product of claim 10, wherein the transfer of the electronic resource comprises a transfer of funds from a financial account associated with the user to a second financial account associated with the second user.

13. The computer program product of claim 10, wherein the transfer vehicle may be stored on the second user device and applied as currency to a future transaction associated with the second user.

14. The computer program product of claim 10, wherein the electronic resource is stored in a digital purse associated with the user, wherein the digital purse is a virtual account associated with the user that is maintained separately from other accounts associated with the user.

15. The computer program product of claim 14, wherein the digital purse has a unique alias that may be provided from the user to the second user in order to direct the transfer of the electronic resource while maintaining anonymity of the user.

16. The computer program product of claim 14, wherein the digital purse has a limit on the amount of funds that are able to be stored within the digital purse.

17. The computer program product of claim 10, wherein transmitting the transfer vehicle from the user device to the second user device further comprises:
transmitting a control signal to the user device to display the transfer vehicle; and
receiving an image of the transfer vehicle via the second user device, wherein the image of the transfer vehicle is captured using the second user device.

18. The computer program product of claim 10, wherein extracting, from the transfer vehicle on the second user device, the routing information associated with the transfer of the electronic resource further comprising matching a record of the routing information associated with the transfer vehicle transmitted from the user device with the routing information extracted from the transfer vehicle received on the second user device.

19. A computer implemented method for manipulating and distributing electronic resources, the method comprising:
receiving a request from a user via a user application stored on a user device associated with the user for a transfer of an electronic resource, wherein the request contains routing information associated with the transfer of the electronic resource;
in response to receiving the request for the transfer of the electronic resource, generating a transfer vehicle, wherein the transfer vehicle is engineered to contain the routing information associated with the transfer of the electronic resource;
inserting and storing the transfer vehicle on the user device;
detecting an interaction event, wherein the interaction event is a request to transmit the transfer vehicle to a second user device associated with a second user;
in response to detecting the interaction event, transmitting the transfer vehicle from the user device to the second user device;
extracting, from the transfer vehicle on the second user device, the routing information associated with the transfer of the electronic resource; and
based on the routing information associated with the transfer of the electronic resource, transferring the electronic resource to a designated location associated with the second user.

20. The computer implemented method of claim 19, wherein transferring the electronic resource to a designated location associated with the second user further comprises:
depositing the electronic resource in an account associated with the second user; and
destroying the transfer vehicle.
